(19) United States
(12) Patent Application Publication
(10) Pub. No.: US 2009/0289912 A1
(43) Pub. Date: Nov. 26, 2009

(54) Touch-sensitive liquid crystal display device with built-in touch mechanism and method and method for driving same

(75) Inventors: Hsin-Li Chen, Miao-Li (TW); Chao-Yi Hung, Miao-Li (TW); Chao-Chin Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/454,873

(22) Filed: May 26, 2009

(30) Foreign Application Priority Data
May 23, 2008 (TW) 97119125

(51) Int. Cl. G06F 3/041

(52) U.S. Cl. 345/173; 345/87

(57) ABSTRACT

A touch-sensitive liquid crystal display (LCD) device includes a first substrate, a second substrate generally opposite to the first substrate, a liquid crystal layer sandwiched between the first substrate and the second substrate, a first scan line, a data line perpendicular to the first scan line, a sensing line parallel to the data line, and a first transistor formed at an inner side of the first substrate adjacent to the liquid crystal layer, and a common electrode formed at an inner side of the second substrate adjacent to the liquid crystal layer. A gate of the first transistor is electrically connected to the first gate line. A drain of the first transistor is electrically connected to sensing line. A source of the first transistor is electrically connectable to the common electrode depending on an external pressure applied on the second substrate.

### BACKGROUND

1. Technical Field

The present disclosure relates to liquid crystal display (LCD) devices, and particularly to a touch-sensitive LCD device with built-in touch mechanism and a method for driving the touch-sensitive LCD device.

2. Description of Related Art

The LCD device has been used as an image display means in a wide variety of applications. A touch panel for inputting signals via a display screen of an LCD device allows a user to select desired information while viewing images without depending on other separate inputting devices such as a keyboard, a mouse or a remote controller. The touch panel thus meets many demands for user-friendly, simplified and convenient operation of an LCD device.

State-of-the-art types of touch panels include resistive, capacitive, acoustic, and infrared (IR) touch panels, among others. One typical touch panel has a rectangular transparent panel, and is stacked on and integrated with an LCD panel of an LCD device. The touch panel is electrically connected to the LCD device and a corresponding control circuit by a flexible printed circuit (FPC), and thereby obtains its touch-control function.

As indicated above, a typical touch panel integrated LCD device is obtained from the LCD panel and the touch panel which are initially individually fabricated. After such fabrication, the separate touch panel is attached to the LCD panel by an adhesive material. Typically, the weight and thickness of the touch-panel integrated LCD device is considerably more than the weight and thickness of the LCD panel alone. That is, the addition of the touch panel and adhesive material to the LCD panel substantially contributes to the total weight of the touch panel integrated LCD device thus obtained. Furthermore, the touch panel and the adhesive material possess optical characteristics which can lead to undesirable effects such as absorption, refraction and reflection. As a result, the touch panel integrated LCD device may suffer from inferior image presentation due to factors such as lower transmittance and optical disturbance.

Therefore, a thinner and lighter touch-sensitive LCD device having superior image presentation is needed.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic, abbreviated circuit diagram of a touch-sensitive LCD device provided by a first embodiment of the present disclosure, the touch-sensitive LCD device including a plurality of pixel units.

FIG. 2 is an enlarged circuit diagram of one pixel unit of the touch-sensitive LCD device of FIG. 1.

FIG. 3 is an enlarged construction of the pixel unit of FIG. 2.

FIG. 4 is a cross-sectional view taken along line IV-IV of FIG. 3.

FIG. 5 is similar to FIG. 4, but showing the touch-sensitive LCD device in an operating condition.

FIG. 6 is a flow chart of an exemplary method for determining the coordinates of the touch-sensitive LCD device of the first embodiment.

FIG. 7 is an enlarged circuit diagram of one pixel unit of a touch-sensitive LCD device provided by a second embodiment of the present disclosure.

FIG. 8 is an enlarged construction of the pixel unit of FIG. 7.

### DETAILED DESCRIPTION

Reference will now be made to the drawings to describe various embodiments in detail.

FIG. 1 is a schematic circuit diagram of a touch-sensitive LCD device provided by a first embodiment of the present disclosure. The touch-sensitive LCD device 100 includes a data driving circuit 101 electrically connected to a plurality of data lines D1-Dm (where “m” is a nature number) for providing data signals thereto, and a scan driving circuit 102 electrically connected to a plurality of scan lines G1-Gn (where “n” is a nature number) for providing scanning signals thereto. The data lines D1-Dm are parallel to each other, with each data line D1-Dm extending along a first direction. The scan lines D1-Dm are parallel to each other, with each scan line G1-Gn extending along a second direction that is perpendicular to the first direction. Thus, a plurality of pixel units 105 are defined by the crossing data lines D1-Dm and the scan lines G1-Gn. The touch-sensitive LCD device 100 provided by the present disclosure further includes a touch control driving circuit 103 electrically connected to a plurality of sensing lines S1-Sm for obtaining touch signals from the sensing lines S1-Sm. The number of sensing lines S1-Sm is equal to the number of data lines D1-Dm, and the plurality of sensing lines S1-Sm are positioned adjacent and parallel to the data lines D1-Dm, respectively.

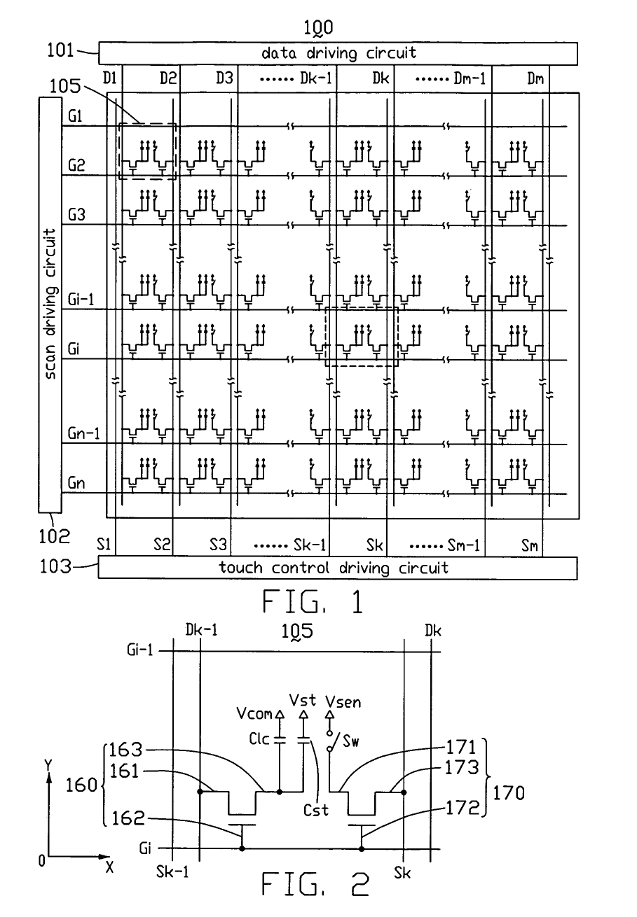

Referring to FIG. 2, this is an enlarged circuit diagram of one pixel unit 105 of the touch-sensitive LCD device 100. The pixel unit 105 includes a thin film transistor (TFT) 160, a second TFT 170, a liquid crystal capacitor Clc, a storage capacitor Cst, and a switch Sw with two terminals (not labeled). The first TFT 160 is positioned at the intersection of the corresponding data line Dk−1 (where 2≦k≦m) and the corresponding scan line Gi (where 2≦i≦m). The first TFT 160 includes a source 161, a gate 162, and a drain 163. The source 161 is electrically connected to the data line Dk−1 for receiving the data signals therefrom. The gate 162 is electrically connected to the scan line Gi for receiving the scanning signals therefrom. The drain 163 is electrically connected to an electrode of the liquid crystal capacitor Clc and an electrode of the storage capacitor Cst for providing the data signals thereto. The other electrode of the liquid crystal capacitor Clc is electrically connected to a common electrode (not shown) for receiving a common voltage. The other electrode of the storage capacitor Cst is provided with a storage voltage Vst.

The second TFT 170 is positioned at the intersection of the corresponding sensing line Sk (where 2≦k≦m) and the corresponding scan line Gi. The second TFT 170 includes a source 171, a gate 172, and a drain 173. The source 171 is electrically connected to one terminal of the switch Sw for receiving touch signals therefrom. The other terminal of the switch Sw is connected to a contact electrode for receiving a sensing voltage Vsen. The gate 172 is electrically connected to the scan line Gi for receiving the scanning signals therefrom. The drain 173 is electrically connected to the sensing line Sk for outputting touch signals thereto. The switch Sw is a pressure-controlled switch. When a pressure is applied on the switch Sw, the switch Sw is switched on, and the sensing voltage is provided to the source 171 of the second TFT 170. When the pressure disappears, the switch Sw is switched off, and the sensing voltage can not be provided to the source 171 of the second TFT 170.

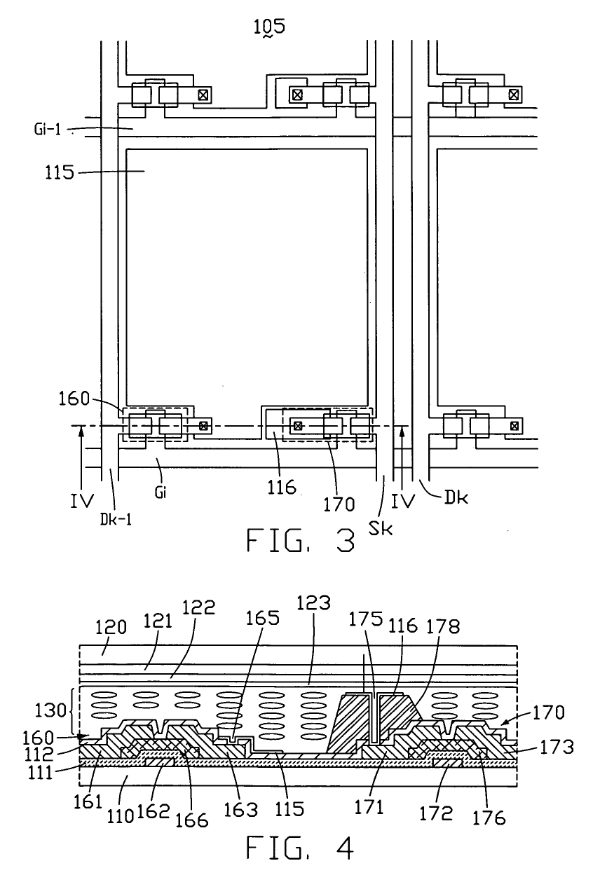

Referring to FIGS. 3-4, FIG. 3 is an enlarged construction of the pixel unit 105, and FIG. 4 is a cross-sectional view taken along line IV-IV of FIG. 3. The touch-sensitive LCD device 100 further includes a first substrate 110, a second substrate 120 parallel and generally opposite to the first substrate 110, and a liquid crystal layer 130 sandwiched between the first substrate 110 and the second substrate 120.

In the exemplary embodiment, the second substrate 120 is a flexible transparent substrate, which is able to provide the touch-sensing function by generating a bending deformation when an external pressure is applied. A color filter layer 121 for displaying red, green and blue colors, and a common electrode 123, is formed at an inner side of the second substrate 120. An overcoat 122 is selectively formed between the common electrode 123 and the color filters 121, in order to planarize the overall structure formed at the inner side of the second substrate 120. The common electrode 123 is formed over the overcoat 122. The common electrode 123 can, for example, be made of indium tin oxide (ITO) or indium zinc oxide (IZO), and is provided with the common voltage Vcom.

The first substrate 110 is a transparent substrate. The scan lines Gi−1, Gi, the data lines Dk−1, Dk, the sensing line Sk, the first TFT 160, and the second TFT 170 are arranged on a side of the first substrate 110 that is adjacent to the liquid crystal layer 130. A pixel electrode 115, which is an electrode of the liquid crystal capacitor Cls is arranged in the pixel unit 105, occupies a majority of the pixel unit 105, and is electrically connected to the drain 163 of the first TFT 160. A contact electrode 116, which is an electrode of the switch Sw, occupies a minority of the pixel unit 105, and is electrically connected to the source 171 of the second TFT 170.

In details, the scan lines Gi−1, Gi, the sensing line Sk, the gates 162, 163 of the first and second TFTs 160, 170 are directly formed on the first substrate 110. A first insulating layer 111 including silicon nitride (SiₓN_{y}) is formed covering the scan lines Gi−1, Gi, the gates 162, 173, and the first sensing line Sk. The form of silicon nitride can for example be Si₃N₄, etc. Semiconductor layers 166, 176 are formed on the first insulating layer 111, corresponding to the gates 162, 172. Each of the semiconductor layers 166, 176 includes a lightly-doped a-Si layer serving as a channel region, and a heavily-doped a-Si layer used to decrease resistance of the lightly-doped a-Si layer. The heavily-doped a-Si layers are discontinuous, such that the semiconductor layers 166, 176 can also be considered to be discontinuous. In particular, each of the semiconductor layer 166, 176 can be considered to have two sides. The source 161 and the drain 163 are formed on the two sides of the semiconductor layer 166, and are generally oriented symmetrically opposite to each other. The source 171 and the drain 173 are formed on the two sides of the semiconductor layer 176, and are generally oriented symmetrically opposite to each other. A second insulating layer 112 is formed covering the sources 161, 171, the semiconductor layers 166, 176, the drain 163, 173, and the first insulating layer 111. In the exemplary embodiment, the second insulating layer 112 includes SiₓN_{y}, wherein SiₓN_{y} can for example be Si₃N₄, etc. A contact hole 165 is formed in the second insulating layer 112, corresponding to the drain 163 of the first TFT 160. The pixel electrode 115 is disposed on the second insulating layer 112, and is electrically connected to the drain 163 via the contact hole 165. The pixel electrode 115, the liquid crystal layer 130, and the common electrode 123 cooperatively form the liquid crystal capacitor Clc.

A protrusion 178 is formed on the second insulating layer 112, corresponding to the source 171 of the second TFT 170. A contact hole 175 is formed in the protrusion 175, and the second insulating layer 112, thereby exposing the source 171. The contact electrode 116 is formed on the protrusion 178 and in the contact hole 175, thereby electrically connecting the source 171 of the second TFT 170. The contact electrode 116 and the common electrode 123 are separated by a gap (not labeled), with the gap being filled with liquid crystal. Thus, the contact electrode 116, the gap, and the common electrode 123 cooperatively define the switch Sw. Because the common electrode 123 is provided with the common voltage. Thus, in this embodiment, the sensing voltage Vsen is equal to the common voltage Vcom.

Referring to FIG. 5, this shows the touch-sensitive LCD device 100 in an operating condition. When no pressure is provided on the second substrate 120, the contact electrode 116 is separated from the common electrode 123. Thus, the switch Sw is regarded as switched off. When external pressure provided by a user's finger (for example) is applied on the second substrate 120, a mechanical deflection such as a bending deformation is formed in the second substrate 120, with the common electrode 123 moving down and completely contacting the contact electrode 116. Therefore the common voltage Vcom is transferred to the source 171 of the second TFT 170. Accordingly, the switch Sw is switched on.

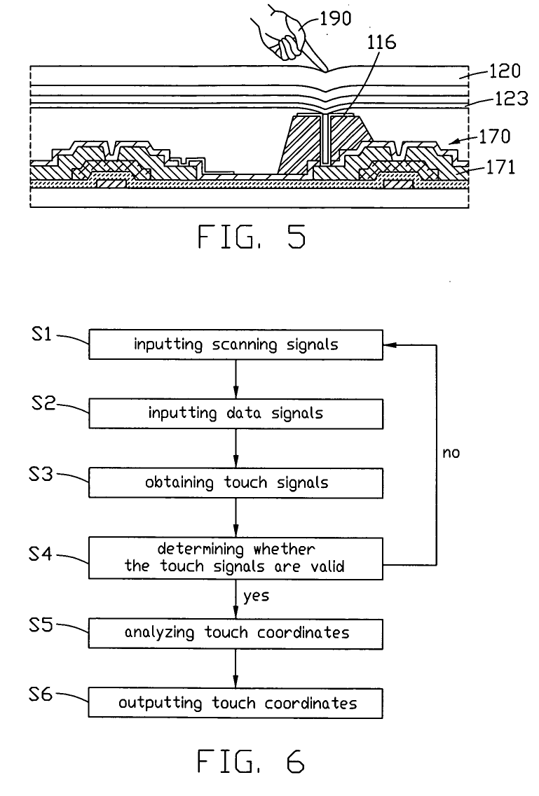

Referring to FIG. 6, this is a flow chart of an exemplary method for determining the coordinates of the touch-sensitive LCD device 100. The method includes: step S1, inputting scanning signals; step S2, inputting data signals; step S3, obtaining touch signals; step S4, determining whether the touch signals are valid; step S5, analyzing touch coordinates; and step S6, outputting touch coordinates. The method is detailed described as bellows, taking the pixel unit 105 shown in FIGS. 2-3 as an example.

In step S1, the scan driver circuit 101 generates a plurality of scanning signals, and inputs them into the scan lines G1-Gn successively. When the scanning signals are provided to the gates 162, 172 of the first and second TFTs 160, 170 via the scan line Gi, the first and second TFTs 160, 170 are switched on.

In step S2, the data driver circuit 102 generates a plurality of data signals, and inputs them into the data line Dk−1. Because the first TFT 160 is switched on, the data signals are provided to pixel electrode 115, charging the liquid crystal capacitor Clc and the storage capacitor Cst, in order to display images.

In step S3, the touch control driving circuit 103 obtains touch signals from the sensing line Sk. If external pressure provided by a user's finger is applied on the second substrate 120, the second substrate 120 bends towards the first substrate 110, and contacts the contact electrode 116. Then the common voltage Vcom is transferred to the source 171 of the second TFT 170. Because the second TFT 170 is switched on, the common voltage Vcom is transferred to the drain 173 of the second TFT 170, then to the touch control driving circuit 103 via the sensing line Sk. Thus, the common voltage Vcom is obtained by the touch control driving circuit 103 as a touch signal, which is used to be determine the touch location. If no pressure is provided to the second substrate 120, the common electrode 123 does not contact the contact electrode 116, and the touch control driving circuit 103 obtains no touch signal.

In step S4, the touch control driving circuit 103 determines whether the received signals are valid. Because electric coupling effect between electric elements of the LCD device 100, some noise signals may be received by the touch control driving circuit 103. Only if the electrical characters, such as current, voltage, frequency etc, of the received signals are in predetermined ranges, the received signals are confirmed as valid touch signals. Then the touch signals are analyzed to determine the coordinates of the touch point. If the received signals are noise signals, the signals are omitted. Then the method proceeds to step S1 and subsequent steps.

In step S5, the valid touch signals are analyzed to determine the coordinates of the touch location. In a rectangular Cartesian coordinate system (x, y) as shown in FIG. 2, each of the scan lines G1-Gn extends parallel to the X-axis. That is, the scan lines G1-Gn correspondingly define a plurality of Y-coordinates Y1-Yn, respectivley. Similarly, the data lines D1-Dm extend parallel to the Y-axis, and correspondingly define a plurality of X-coordinates X1-Xm, respectively. When a touch signal is received by the touch control driving circuit 103, an X-coordinate Xk of the sensing line Sk, from which the touch signal is transferred, is also the X-coordinate of the touch point.

The scanning signal of each scan lines G1-Gn has a corresponding scanning time sequence. The scanning time sequence defines a plurality of scanning times of the scan lines G1-Gn. Only when the scan line Gi is scanned, the common voltage can be transferred to the touch control driving circuit 103 via the second TFT 170. The touch control driving circuit 103 compares the scanning time of the scan line Gi with the scanning time sequence to confirm the corresponding physical address, that is, the Y-coordinate Yi of the scan line Gi is determined. The Y-coordinate Yi is also the Y-coordinate of the touch point.

By the above-described method, precise coordinates (Xk, Yi) of the touch point are obtained.

Compared with the related touch panel LCD devices, the touch-sensitive LCD device 100 further includes a touch control driving circuit 103, a plurality of sensing lines S1-Sm, a plurality of second TFTs 170, and a plurality of switches Sw that are arranged and structured to achieve the touch function. Thus the touch-sensitive LCD device 100 obtains the function of touch-control on its own without attaching any separate touch panel. Consequently, the provided touch-sensitive LCD device 100 is thinner, lighter, and more competitive in the development of touch-control display device. In addition, since the touch panel and the adhesive material are eliminated from the provided touch-sensitive LCD device 100, adverse optical effects such as absorption, refraction, reflection and interference are reduced. Accordingly, signal transmittance and image presentation of the touch-sensitive LCD device 100 are improved as well.

Furthermore, the method for determining the coordinates of the touch-sensitive LCD device 100 is integrated with the display driving method, the method is relatively concise and precise.

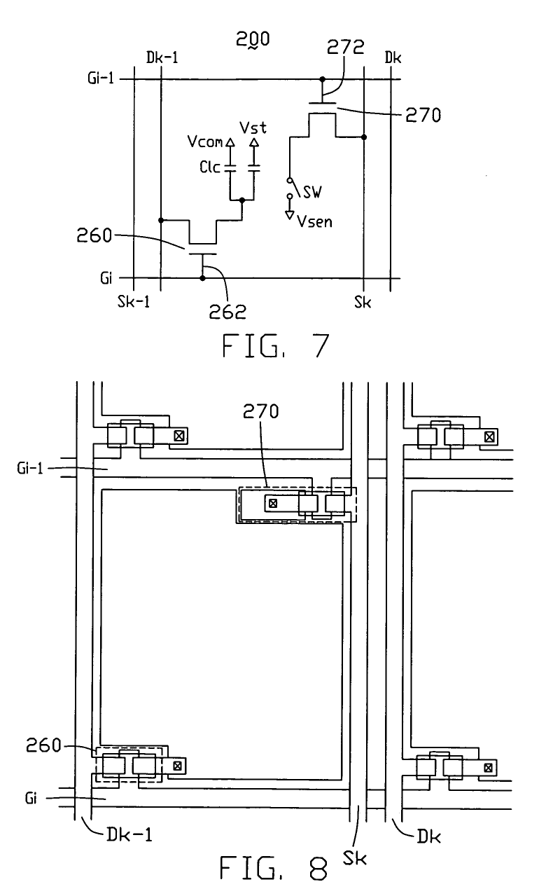

Referring to FIGS. 7-8, FIG. 7 is an enlarged circuit diagram of one pixel unit of a touch-sensitive LCD device provided by a second embodiment of the present disclosure, FIG. 8 is an enlarged construction of the pixel unit of FIG. 7.

The touch-sensitive LCD device 200 is similar to the touch-sensitive LCD device 100 of the first embodiment, only differs in that: in each pixel unit, a first TFT 260 is positioned at the intersection of the corresponding data line Dk−1 (where 2≦k≦m) and the corresponding scan line Gi (where 2≦i≦m), with a gate 262 electrically connected to the scan line Gi, and a second TFT 270 is positioned at the intersection of a corresponding sensing line Sk (where 2≦k≦m) and the corresponding scan line Gi−1, which is prior to the scan line Gi. Thus, the scan line Gi−1 is arranged for scan the second TFT 270, and the scan line Gi is arranged for scan the first TFT 260. Thus, the first and second TFTs 260, 270 are scanned by different scan lines Gi, Gi−1. This further eliminates an interference between the first and second TFTs 260, 270, and increases stability and precision of the touch function.

It is to be understood that even though numerous characteristics and advantages of the present embodiments have been set forth in the foregoing description, with details of the structures and functions of the embodiments, the disclosure is illustrative only; and that changes may be in detail, especially in matters of shape, size, and arrangement of parts, within the principles of the embodiments, to the full extent indicated by the broad general meaning of the terms in which the appended claims are expressed.

What is claimed is:

1. A touch-sensitive liquid crystal display (LCD) device, comprising:
a first substrate;
a second substrate generally opposite to the first substrate;
a liquid crystal layer sandwiched between the first substrate and the second substrate;
a first scan line, a data line perpendicular to the first scan line, a sensing line parallel to the data line, and a first transistor formed at an inner side of the first substrate adjacent to the liquid crystal layer; and
a common electrode formed at an inner side of the second substrate adjacent to the liquid crystal layer;
wherein, a gate of the first transistor is electrically connected to the first gate line, a drain of the first transistor is electrically connected to sensing line, and a source of the first transistor is electrically connectable to the common electrode depending on an external pressure applied on the second substrate.

2. The touch-sensitive LCD device of claim 1, further comprising a pixel electrode and a second transistor with a gate electrically connected to the first gate line, a source electrically connected to the data line, and a drain electrically connected to the pixel electrode.

3. The touch-sensitive LCD device of claim 1, further comprising a pixel electrode, a second scan line, and a second transistor with a gate electrically connected to the second gate line, a source electrically connected to the data line, and a drain electrically connected to the pixel electrode.

4. The touch-sensitive LCD device of claim 1, further comprising a contact electrode electrically connected to the source of the first transistor, the source of the first transistor is electrically connectable to the common electrode via the contact electrode depending on an external pressure applied on the second substrate.

5. The touch-sensitive LCD device of claim 1, further comprising a data driving circuit for providing data signals to the data line, a scan driving circuit for providing scanning signals to the first scan line, and a touch control driving circuit for obtaining touch signals from the sensing line.

6. The touch-sensitive LCD device of claim 5, wherein the common electrode is provide with a common voltage, when the first scan line is scanned and the common electrode is electrically connected to the source of the first transistor, the common voltage is transferred to the touch control driving circuit via the first transistor and the sensing line.

7. The touch-sensitive LCD device of claim 3, further comprising a spacer positioned between the common electrode and the second electrode, and a thickness of the spacer is smaller than a gap between the common electrode and the second electrode.

8. A touch-sensitive liquid crystal display (LCD) device, comprising:
a common electrode;
a first scan line;
a sensing line;
a contact electrode; and
a switch with a control terminal connected to the scan line for receiving a control signal, a first connecting terminal connected to the contact electrode, and a second connecting terminal connected to the sensing line;
wherein the common electrode is connectable to the contact electrode depending on an external pressure applied on the second substrate.

9. The touch-sensitive LCD device of claim 8, wherein the switch is a transistor, a gate of the transistor corresponding to the control terminal, a source corresponding to first connecting terminal, and a drain corresponding to the second connecting terminal.

10. The touch-sensitive LCD device of claim 9, further comprising a first substrate, a second substrate opposite to the first substrate, and a liquid crystal layer sandwiched between the first and second substrates.

11. The touch-sensitive LCD device of claim 10, further comprising a protrusion arranged corresponding to the source of the transistor, the contact electrode being arranged on the protrusion and connected to the source of the transistor.

12. The touch-sensitive LCD device of claim 10, further comprising a second transistor, a pixel electrode, and a data line parallel the sensing line at the inner side of the first substrate, the second transistor comprising a gate connected to the first scan line, a source line connected to the data line, and a drain connected to the pixel electrode.

13. The touch-sensitive LCD device of claim 10, further comprising a second transistor, a pixel electrode, a second scan line parallel to the first scan line, and a data line parallel the sensing line at the inner side of the first substrate, the second transistor comprising a gate connected to the second scan line, a source line connected to the data line, and a drain connected to the pixel electrode.

14. The touch-sensitive LCD device of claim 12, further comprising a data driving circuit for providing data signals to the data line, a scan driving circuit for providing scanning signals to the first scan line, and a touch control driving circuit for obtaining touch signals from the sensing line.

15. A method for driving a touch-sensitive liquid crystal display (LCD) device, the touch-sensitive LCD device comprising a common electrode, a first scan line, a sensing line, a contact electrode, and a switch with a control terminal connected to the scan line, a first connecting terminal connected to the contact electrode, and a second connecting terminal connected to the sensing line, the common electrode being connectable to the contact electrode depending on an external pressure applied on the second substrate, the method comprising:
scanning the first scan line to switch on the switch;
obtaining touch signals of a touch location from the sensing line;
analyzing coordinates of the touch location.

16. The method of claim 15, wherein the touch-sensitive LCD device further comprises a pixel electrode, a data line parallel the sensing line, and a transistor with a gate connected to the first scan line, a source line connected to the data line, and a drain connected to the pixel electrode, when the first scan line is scanned, the transistor is switched on, and a data signal is provide to the data line.

17. The method of claim 15, wherein the touch-sensitive LCD device further comprises a pixel electrode, a second scan line parallel to the first scan line, a data line parallel the sensing line, and a transistor with a gate connected to the second scan line, a source line connected to the data line, and a drain connected to the pixel electrode, the method further comprises: scanning the second scan line to switch on the transistor; providing data signals to the data line.

18. The method of claim 15, wherein the touch-sensitive LCD device further comprises a data driving circuit for providing data signals to the data line, a scan driving circuit for providing scanning signals to the first scan line, and a touch control driving circuit for obtaining touch signals from the sensing line.
